(19) United States
(12) Patent Application Publication
(10) Pub. No.: US 2010/0189995 A1
(43) Pub. Date: Jul. 29, 2010

(54) DUPLEX-ALUMINIUM MATERIAL BASED ON ALUMINIUM WITH A FIRST PHASE AND A SECOND PHASE AND METHOD FOR PRODUCING THE DUPLEX-ALUMINIUM MATERIAL

(75) Inventors: Horst Adams, Altstatten (CH); Michael Dvorak, Thun (CH)

Correspondence Address: BANNER & WITCOFF, LTD., TEN SOUTH WACKER DRIVE, SUITE 3000, CHICAGO, IL, 60606, US

(73) Assignee: ALCAN TECHNOLOGY & MANAGEMENT AG, Neuhausen am Rheinfall (CH)

(21) Appl. No.: 12/669,414

(22) PCT Filed: Jul. 18, 2008
(86) PCT No.: PCT/EP08/05883

§ 371 Date: Jan. 15, 2010

(30) Foreign Application Priority Data
Jul. 18, 2007 (EP) 07014024.9

(51) Int. Cl. B32B 9/00; H01B 1/04; B32B 27/06; C22C 21/00

(52) U.S. Cl. 428/323; 252/503; 428/339; 420/528; 977/742

(57) ABSTRACT

The invention relates to the processing of a composite material in particle or powder form, containing carbon nanotubes (CNT), said material having metal with a thickness of between 10 nm and 500,000 nm that is layered alternately with carbon nanotubes of a thickness of between 10 nm and 100,000 nm. The material is produced by mechanical alloying, i.e. by repeated deformation, breakage and welding of metal particles and CNT particles, preferably by milling in a pebble mill containing a milling chamber and milling pebbles as the milling bodies and to a rotating body for creating highly energetic pebble collisions. The invention discloses a method for producing duplex-aluminium, in which a material is alloyed as a combination of the composite material and an aluminium alloy with different characteristics in an Ospray process.

The invention relates to a duplex-aluminium material based on aluminium with a first phase and a second phase which is produced by a spray compacting method, with at least a first material component introduced by means of a first jet in the form of an aluminium-based alloy to form the first phase and at least a second material component introduced by means of a second jet to form the second phase. The invention further relates to a method for producing the duplex-aluminium material.

Carbon nanotubes are known. Further equivalent terms for carbon nanotubes are nanoscale carbon tubes or carbon nano tubes and the abbreviation “CNT”. The most common form in specialist circles, namely “CNT” will continue to be used below. CNTs are fullerenes and are carbon modifications with a closed polyhedral structure. Known areas of use for CNTs are to be found in the area of semiconductors or to improve the mechanical properties of conventional plastics materials (www.de.wikipedia.org under “carbon nanotubes”).

Moreover, Al/CNT composites are known from ESAWI A ET AL: “Dispersion of carbon nanotubes (CNTs) in aluminium powder”COMPOS PART A APPL SCI MANUF; COMPOSITES PART A: APPLIED SCIENCE AND MANUFACTURING FEBRUARY 2007, [online] Vol. 38, no. 2, 23 Jun. 2006 (23-6-2006), pages 646-650 and EDTMAIER C ET AL: “Aluminium based carbon nanotube composites by mechanical alloying” POWDER METALLURGY WORLD CONGRESS & EXHIBITION (PM2004) 17-21 OCT. 2004 VIENNA, AUSTRIA, 17 October 2004 (17-10-2004), -21 Oct. 2004 (21-10-2004) page 6 pp. and GEORGE ET AL: “Strengthening in carbon nanotube/aluminium (CNT/Al) composites” SCRIPTA MATERIALIA, ELSEVIER, AMSTERDAM, NL, Vol. 53, No. 10, November 2005 (11-2005), pages 1159-1163 and CARRENO-MORELLI E ET AL: “Carbon nanotube/magnesium composites” PHYS STATUS SOLIDI A; PHYSICA STATUS SOLIDI (A) APPLIED RESEARCH JUNE 2004, Vol. 201, No. 8, June 2004 (6-2004), pages R53-R55 and C. EDTMAIER: “Metall-Matrix-Verbundwerkstoffe mit Carbon Nanotubes als hochfeste and hochwarmeleitende Einlagerungsphase” [Online] 3 Jun. 2005 (3-6-2005), XP002413867 found on the internet: URL :http ://www.ipp .mpg.de/de/for/bereiche/material/seminare/MFSem/talks/Edtmaier_{—}0 3-06-2005.pdf> [found on Sep. 1, 2007] as well as THOSTENSON ET AL: “Nanocomposites in contect” COMPOSITES SCIENCE AND TECHNOLOGY, Vol. 65, 2005, pages 491-516.

Application methods for alloys containing aluminium are disclosed inter alia as an Ospray process. EP 0 411 577 discloses a hypereutectic aluminium alloy, which is sprayed on by the Ospray method in the molten state from a first nozzle, solid silicon particles or graphite particles, optionally as Si-metal or a graphite-metal compound being simultaneously sprayed from a further nozzle, without these demixing and these being thus applied to a carrier device and solidifying there to form a block of a duplex-aluminium alloy.

DE 43 08 612 Al discloses the production of an aluminium-duplex alloy with boron fractions, with good properties such as formability, corrosion-resistance and heat resistance etc. The boron is applied, for example by means of a powdery carrier material using an additional spray jet in the spray jet of the melt of the remaining alloy constituents, or directly onto the sprayed product carrier in a spray compacting device.

DE 100 47 775 C1 discloses the possibility of producing a copper-aluminium multi-alloy bronze in an Ospray process.

DE 103 06 919 A1 discloses the production of a composite material with intermetallic phases in the course of spray compacting based on an arc-wire spray method with one or more solid metal wires and at least one composite wire having a ceramic.

The object of the present invention is to expand the area of use of the CNTs and to propose new materials and moulded bodies therefrom.

The object is achieved by the invention by a duplex-aluminium material of the type mentioned at the outset and a method for producing a duplex-aluminium material as a combination of two materials with different properties.

The invention for this purpose proceeds from a duplex-aluminium material based on aluminium with a first phase and a second phase according to the type mentioned at the outset and, in the process, provides according to the invention that the second material component is in the form of an aluminium-based composite material, having aluminium and/or an aluminium-based alloy on the one hand, and material containing a non-metal on the other hand, the first material component, in comparison to the second material component, in each case as a separate material, having higher ductility and/or lower tensile strength.

With regard to the production method, the object is achieved by the invention by means of a method for producing the duplex-aluminium material having the steps:

processing fractions of aluminium and/or an aluminium-based alloy and a non-metal, in each case in the form of granulates, particles, fibres and/or powders by mechanical alloying, in order to provide the second material component in the form of an aluminium-based composite material, having aluminium and/or an aluminium-based alloy on the one hand, and a material containing a non-metal on the other hand;

spray compacting the duplex-aluminium material based on aluminium with a first phase and a second phase; by:

introducing a first material component in the form of an aluminium-based alloy to form the first phase in at least a first jet;

introducing the second material group to form the second phase in at least a second jet; wherein the first material component, in comparison to the second material component, in each case as a separate material, has a higher ductility and/or lower tensile strength. In a quite particularly preferred development of the invention, the non-metal is in the form of CNTs. It has been shown in an advantageous manner that the spray compacting method can preferably be carried out in the form of an Ospray process.

The ductility or tensile strength of a material component is to be related in each case to the material component present as a separate material. In other words, the ductility of a first material in the form of pure aluminium is compared, for example, with the ductility of a second material in the form of an aluminium-CNT composite. In a particularly preferred manner, the second material component, in comparison to the first material component, again as a separate material, has a lower ductility and/or higher tensile strength.

Duplex-aluminium consists of two different structural types: in the duplex-aluminium, two substantially single-phase aluminium-based materials are preferably united, preferably in approximately equal parts to exploit their respective positive material properties. Mechanical-technological properties such as tensile strength, robustness and hardness, but also corrosion-chemical properties, in other words rust-resistance, are meant.

Duplex-aluminium may, for example, be distinguished by high corrosion-resistance, above all with respect to hole and stress crack corrosion and high strength characteristics and increased heat-resistance.

Based on this concept, the invention provides suitable duplex-aluminium materials.

The invention proceeds from the consideration of combining two or more different alloys to form a so-called aluminium-duplex alloy. It is thus the object of this invention to combine an alloy with a very high tensile strength but low ductility with a different alloy with a low tensile strength but high ductility.

In a preferred development—similar to the Ospray method—one alloy, preferably that with high ductility but also pure aluminium, may be melted, for example in a crucible and sprayed through a nozzle. The alloy with the high tensile strength is sprayed in in powder form in this spray jet of liquid aluminium drops. This has the advantage that alloys reinforced with nanoparticles can also be sprayed in here in powder form without a demixing of the nanoparticles from the aluminium matrix taking place.

The sprayed-in particles are then advantageously also briefly melted in the hot cloud of liquid drops, mixed homogeneously and after a very short flight time deposited together on a substrate, where the material immediately solidifies (rapid solidification). In this case, the flight time in the liquid phase for the sprayed-in powder particles is expediently so short that no demixing of the nanoparticles from the surrounding aluminium takes place.

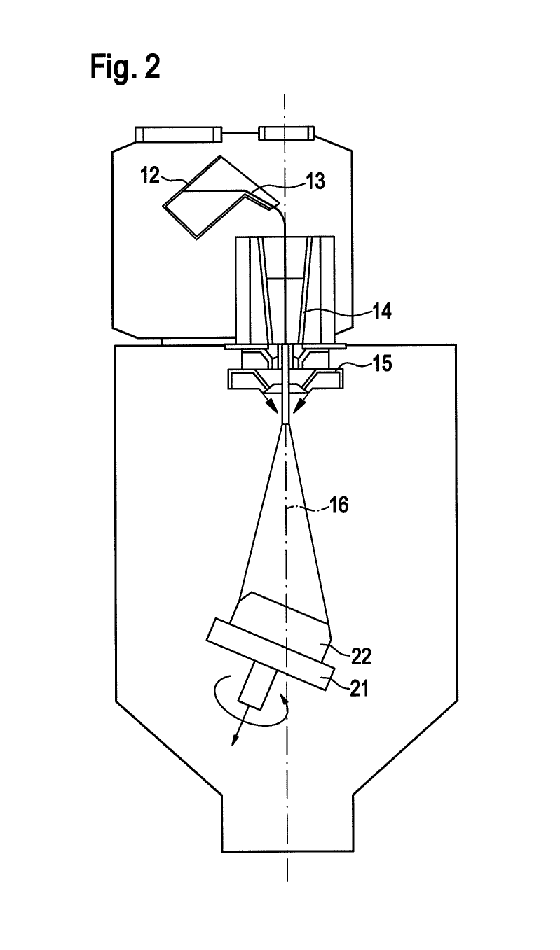

It is to be understood that the step of spray compacting in the production method according to the concept of the invention may have different developments. Thus—this with exemplary reference to FIG. 2 of the detailed description—for example the step of spray compacting may be carried out with a single spray jet, the carrier substance of which is formed from the first material component, the second material component being sprayed in in powder form into this spray jet. In a modification—this with exemplary reference to FIG. 11—the step of spray compacting may also be carried out with two different spray jets. Thus, in a further development, a first spray jet can be used merely to apply the first material component in the form of an aluminium-based alloy on a substrate to form a compact test specimen, for example in the form of a bar or billet or the like. Collinearly or at an angle to this, in this development, the second spray jet can be used to deposit the second material component on the substrate. In the aforementioned further development, the first spray jet would therefore practically exclusively be used to introduce the first material component, while the second spray jet is used practically exclusively to introduce the second material component. The second material component is in this case introduced similarly in the previously mentioned development, namely in that the alloy with the high tensile strength is sprayed in in powder form into the carrier formed from pure aluminium or an aluminium alloy, of the second spray jet. In this development, an introduction in powder form of the alloy with high tensile strength in the first spray jet is not provided.

In a further development, the first spray jet can certainly also be used to deposit the second material component on the substrate, in that the alloy with the high tensile strength is also sprayed in powder form into the first spray jet. Optionally, the quantity of alloy with the high tensile strength sprayed in into a first and/or second spray jet in powder form may be different.

Which of the previously mentioned developments proves expedient in detail may be adjusted as necessary depending on the aimed for material according to the invention.

Preferably, similar to in the Ospray method, layer upon layer may be deposited one above the other on the substrate, so over time a compact test specimen is produced as a combination of the two different alloys. The mixing ratio may be adjusted in this case by varying the delivery quantity of the sprayed-in powder.

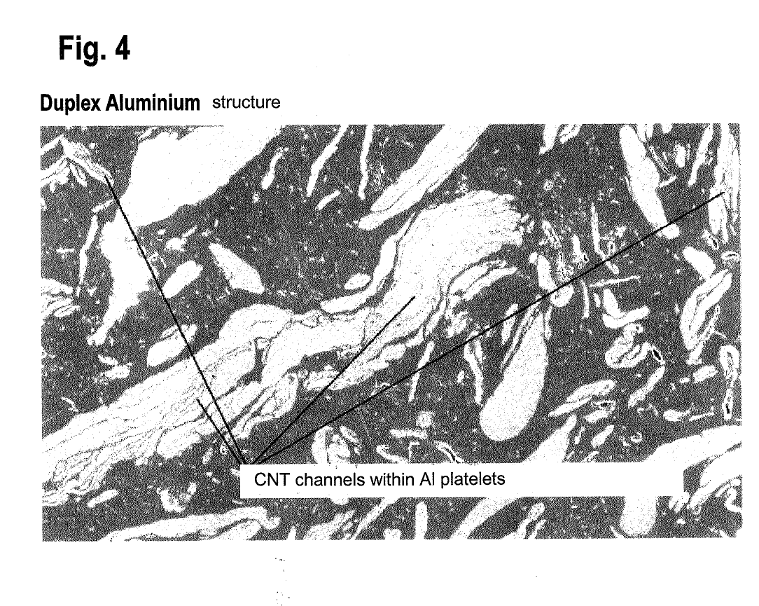

The result is a material with high tensile strength with simultaneously high ductility. Thus, for example, FIG. 4 shows a duplex-aluminium structure. The light parts are the high-strength structural constituents with integrated CNTs and the dark parts represent the soft structural constituents.

Methods are described below, in particular for producing aluminium alloys reinforced by nanoparticles (for example CNTs). These alloys, compared to pure aluminium, as a function of the CNT concentration, have a substantially higher tensile strength (for example factor 5) but simultaneously also a reduced ductility as a function of the CNT concentration. Apart from the CNT content, the two material properties are also influenced by other process parameters, such as, for example, the material temperature during production. Thus it is possible to adjust an area of possible tensile strength/ductility combinations for a special aluminium alloy by varying these process parameters.

Further advantageous developments of the invention can be inferred from the sub-claims and provide advantageous possibilities in detail for implementing the concept described above in the course of setting the object and with respect to further advantages. A particularly preferred first material concept, again present as a separate material, has a lower tensile strength than the second component and a higher maximum elongation—in other words is, in particular, the softer material component. The second material component, in a particularly preferred manner, again given for a separately present material, has a higher tensile strength and a lower maximum elongation, i.e. ductility—in other words is, in particular, the harder material component. This second material component has proven to be particularly easy to produce, in particular using CNTs and is moreover suitable, in a particular manner, in combination with the first material component to form a duplex-aluminium material.

It has proven to be particularly advantageous that the tensile strength of the first material component is less than 100 MPa and, at the same time, a maximum elongation of more than 15% is present. In one modification, at least one of the parameters, tensile strength or elongation, may be within the limits mentioned. A first material component has proven to be quite particularly preferred, in which a tensile strength is below 70 MPa and a maximum elongation is more than 20%. In a modification of the development last-mentioned, only one of the parameters, tensile strength or elongation, is within the limits mentioned.

The second material component may advantageously be provided with a tensile strength of more than 500 MPa and simultaneously with a maximum elongation (ductility) of less than 3%. In a modification, at least one of the parameters, tensile strength or elongation, may be within the limits mentioned. A second material component has proven quite particularly preferred, in which a tensile strength is above 1000 MPa, and a maximum elongation (ductility) of less than 1% is present. In a modification of the development last-mentioned, only one of the parameters, tensile strength or elongation, is within the limits mentioned.

Moreover, it has proven to be advantageous that, in the second material component—proceeding from a conventional aluminium alloy or proceeding from a conventional pure aluminium—an aluminium material is used, which has a CNT content such that a reduction of a maximum elongation in comparison to the aluminium material without a CNT content is below 30%, advantageously below 10%. Aluminium materials of this type provided with elongation reduced to a limited extent have proven to be particularly preferred for the second material component. With regard to the configuration of the second material component, reference is made to FIG. 13 of the detailed description.

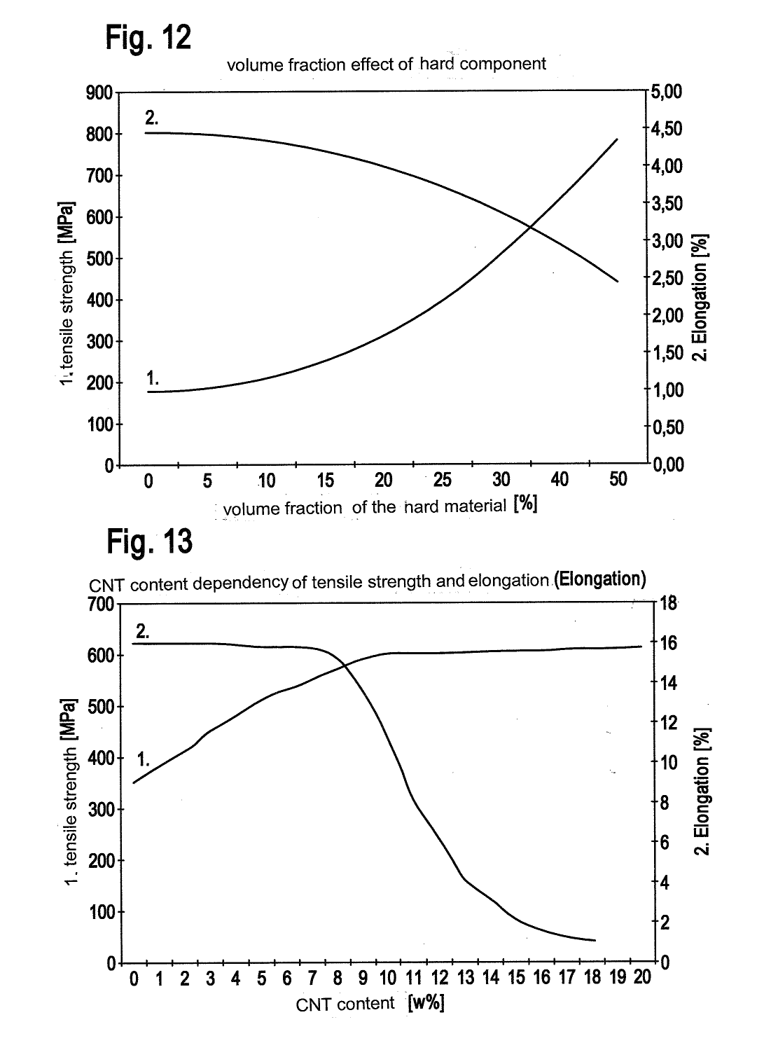

With regard to the further composition of the first and second material component for forming a duplex-material, reference is made to FIG. 12 of the detailed description. The lower the fraction of the (harder) second material component in the duplex-aluminium material, the more flexible and softer the latter proves to be. The lower the fraction of (softer) first material component in the duplex-aluminium material, the more inflexible and harder is the latter.

In a particularly preferred development, the first material component is in the form of pure aluminium or in the form of an aluminium alloy, in each case with inevitable impurities and/or additions. The second material component has been proven in a particularly preferred development above all in the form of a mixture, preferably intimate mixture, of pure aluminium and/or an aluminium-based alloy on the one hand, and CNTs on the other hand. The intimate mixture is preferably implemented in the form of a mixture formed by mechanical alloying. Particularly preferred mechanical alloying methods are described in detail below.

The first and/or the second material component according to the concept of the invention or a development thereof may, moreover, expediently have a further constituent, which may be selected in an advantageous manner depending on the application. A further constituent may, in particular, be a plastics material and/or a polymer and/or a highly-heat resistant constituent. It has been shown that highly heat-resistant constituents may, for example, be in the form of a graphite and/or silicon constituent. An SiC constituent and/or an Al₂O₃ constituent has also proven to be particularly suitable.

The concept can advantageously be implemented by materials containing at least one metal and/or at least one polymer, in particular layered, alternately with layers of CNTs.

The second material component is advantageously present in granular form or in the form of particles, the particle size being 0.5 μm to 2000 μm, advantageously from 1 μm to 1000 μm. The individual layers or strata of the metal or polymer may have a thickness of 10 nm to 500,000 nm, advantageously from 20 nm to 200,000 nm. The thicknesses of the individual layers or strata of the CNTs may be from 10 nm to 100,000 nm, advantageously from 20 nm to 50,000 nm.

Suitable metals are those such as ferrous and non-ferrous metals and precious metals. Suitable ferrous metals are iron, cobalt and nickel, alloys thereof and steels. Aluminium, magnesium and titanium etc. and alloys thereof can be included in the non-ferrous metals. Further examples of metals which can be mentioned are vanadium, chromium, manganese, copper, zinc, tin, tantalum or tungsten and alloys thereof or the alloys brass and bronze. Rhodium, palladium, platinum, gold and silver may also be used. The metals mentioned may be of one type alone or be used in mixtures with one another. Aluminium and alloys thereof are preferred. Apart from pure aluminium, the alloys of aluminium are preferred. The metal is used in a grainy manner or in granular or powder form in the method according to the invention. Typical grain sizes of the metals are from 5 μm to 1000 μm and expediently from 15 μm to 1000 μm.

Thermoplastic, elastic or thermosetting polymers are suitable as polymers. Examples are polyolefins such as polypropylene or polyethylene, cycloolefin copolymers, polyamides, such as polyamide 6, 12, 66, 610 or 612, polyesters, such as polyethylene terephtalate, polyacrylonitrile, polystyrenes, polycarbonates, polyvinyl chloride, polyvinyl acetate, styrene-butadiene copolymers, acrylonitrilebutadiene copolymers, polyurethanes, polyacrylates and copolymers, alkyd resins, epoxides, phenol-formaldehyde resins, urea formaldehyde resins etc. The polymers are used as one type alone or in a mixture with one another or in a mixture with metal, in each case in a grainy manner or in granular or powder form in the method according to the invention. Typical grain sizes of the polymers are from 5 μm to 1000 μm and expediently from 15 μm to 1000 μm.

Materials produced, for example catalytically, in an arc by means of laser or by gas decomposition may be used as CNTs. The CNTs may be single-walled or multi-walled, such as two-walled. The CNTs may be open or closed tubes. The CNTs may, for example, have diameters from 0.4 nm (nanometres) to 50 nm and have a length of from 5 nm to 50,000 nm. The CNTs may also have a sponge-like structure, i.e. be 2- or 3-dimensional structural bodies of mutually cross-linked carbon nanotubes. The diameter of the individual tubes varies within the range stated above from, for example 0.4 nm to 50 nm. The extent of the foam structure, i.e. the side lengths of a structural body of CNTs, may be given by way of example as 10 nm to 50,000 nm, advantageously 1,000 nm to 50,000 nm in each of the dimensions.

The material according to the present invention may, for example, contain 0.1 to 50% by weight, based on the material, of CNTs. Expediently, quantities of 0.3 to 40% by weight, preferably from 0.5 to 20% by weight and in particular 1 to 10% by weight of CNTs are contained in the material. If aluminium or an aluminium alloy is the metal of the material, the material may expediently contain 0.5 to 20% by weight of CNTs, based on the material, 3 to 17% by weight CNTs being preferred and 3 to 6% by weight of CNTs being particularly preferred.

The materials may consist of said metals and said CNTs, they may consist of said metals, polymers and CNTs or may consist of said polymers and CNTs or the materials stated above may contain additional admixtures, for example functional admixtures. Functional admixtures are, for example, carbon, also in carbon black, graphite and diamond modification, glasses, carbon fibres, plastic fibres, inorganic fibres, glass fibres, silicates, ceramic materials, carbides or nitrides of aluminium or silicon, such as aluminium carbide, aluminium nitride, silicon carbide or silicon nitride, for example also in fibre form, for example so-called whiskers.

The duplex-aluminium material according to the invention can be produced in that by mechanical alloying the respective fractions of metal, polymer and CNTs are provided for the second material component. Mechanical alloying can be carried out by repeated deformation, breaking and welding of powdery particles of the metal or the polymer and the CNTs. Pebble mills with highly energetic pebble collisions are particularly suitable according to the invention for mechanical alloying. A suitable energy input is achieved, for example in pebble mills, the milling chamber of which has a cylindrical, preferably circular cylindrical cross section and the milling chamber is generally arranged in a horizontal position. The milling product and the milling pebbles are moved by the milling chamber rotating about its cylinder axis and additionally further accelerated by a driven rotating body extending in the direction of the cylinder axis into the milling chamber and equipped with a plurality of cams. The speed of the milling pebbles is advantageously adjusted to 4 m/s and higher, expediently to 5 m/s, in particular 11 m/s and higher. Speeds of the milling pebbles in the range of 6 to 14 m/s, in particular 11 to 14 m/s are advantageous. A rotating body is also advantageous, the plurality of cams of which are arranged distributed over the entire length. The cams may extend, for example over 1/10 to 9/10, preferably 4/10 to 8/10 of the radius of the milling chamber. A rotating body is also advantageous, which extends over the entire extent of the milling chamber in the cylinder axis. The rotating body, like the milling chamber, driven independently of one another or synchronously, is set in motion by an external drive. The milling chamber and the rotating body may rotate in the same direction or preferably in the opposite direction. The milling chamber may be evacuated and the milling process operated in a vacuum or the milling chamber may be filled with a protective or inert gas and operated. Examples of protective gases are, for example N₂, CO₂, and of inert gases are He or Ar. The milling chamber and therefore the milling product may be heated or cooled. The milling may take place cryogenically on a case by case basis.

A milling period of 10 hours and less is typical. The minimum milling period is expediently 15 min. A milling period of between 15 min and 5 hours is preferred. Particularly preferred is a milling period of 30 min to 3 hours, in particular up to 2 hours.

The pebble collisions are the main reason for the energy transfer. The energy transfer can be expressed by the formula Eₖᵢₙ=mv², m being the mass of the pebbles and v the relative speed of the pebbles. The mechanical alloying in the pebble mill is generally carried out with steel pebbles, for example with a diameter of 2.5 mm and a weight of about 50 g or with zirconium oxide pebbles (ZrO₂) with the same diameter with a weight of 0.4 g.

In accordance with the energy input into the pebble mill, materials with a preferred distribution of the layers of metal or polymer and CNTs may be produced. With an increasing energy input, the thickness of the individual layers may be varied. Apart from the energy input, the thickness of the CNT layers in the milled material can be controlled by the thickness of the CNT structure supplied to the milling process. With an increasing energy input, the thickness of the individual layers can be reduced and the respective layer can be increased with respect to the area extent. Owing to the increasing area extent, individual layers of CNTs may contact one another for example through to CNT layers continuing in two dimensions or CNT layers contacting one another continuing in two dimensions through a particle. Thus it is possible to substantially retain the excellent properties of the CNTs, for example the heat conductivity and the electrical conductivity of the CNTs on the one hand, and the ductility of the metal or the elasticity of the polymer on the other hand, in the second material component.

A further control of the properties of the second material component may be achieved by mixing two or more materials of a different starting material and/or energy input during the production thereof. Materials such as metal or plastics material, free of CNTs, and one or more materials containing CNTs can also be mixed or mechanically alloyed, i.e. milled. The different materials may be mixed on a case by case basis with the materials or subjected to a second milling or a plurality of millings. The second milling or subsequent millings may last, for example, for a milling period of 10 hours and less. The minimum time period of the second milling is expediently min. A second milling period is preferably between 10 min and 5 hours. A second milling duration of 15 min to 3 hours, in particular up to 2 hours, is particularly preferred.

A second material component with a high CNT content and a material with a lower CNT content or materials with a different energy input may, for example, be processed in a second milling process. A material containing CNT, such as a CNT-containing metal, for example aluminium, may also be processed with a CNT-free metal, for example also aluminium, in a second milling process. The second milling process or a plurality of milling processes, or the mechanical alloying, is in this case only carried out to such an extent that the resulting material is not completely homogenised, but the inherent properties of each material are retained and supplement the effects in the final material.

With the described method, the properties inherent to the CNTs which make a targeted processing impossible, such as a lower specific weight compared to the specific weight of metals and the poor cross-linking capacity of the CNTs by metals, can be overcome. Thus, 2.7 g/cm³ can be given as an example of the different density for aluminium and 1.3 g/cm³ for the CNTs.

The second material component is used, for example, in moulded bodies, including semi-finished goods and layers, which are produced by spray compacting, thermal spraying methods, plasma spraying, extrusion methods, sintering methods, pressure-controlled infiltration methods or pressure casting.

The present second material component can accordingly be processed, for example, by spray compacting into moulded bodies. During the spray compacting, a metal melt, for example from a steel, magnesium or preferably aluminium or an aluminium alloy is supplied by way of a heated crucible to a spray head, atomised there into fine drops and sprayed onto a substrate or base. The initially still molten drops cool during flight from the atomisation device to the substrate located below. The particle flow impacts there at a high speed in order to grow to the so-called deposit and to completely solidify in the process and further cool. In spray compacting, the particular phase transition “liquid to solid” hardly to be defined exactly as a state of small melt particles growing together to form a closed material bond is used for the forming process. In the present case, the second material component, containing the CNT, is supplied in powder form to the atomising device and fine metal drops are sprayed from the spray process of the metal melt. The conducting of the process is such that the materials containing the CNTs are not melted or only on the surface and a demixing does not take place. The particle flow of the material and metal drops impacts on the substrate at a high speed and grows to the deposit. In accordance with the substrate, such as rotary disk, rotary rod or table, solid bodies such as bars, hollow bodies such as tubes or metal strips such as metal sheets or profiles, can be produced as moulded bodies. The deposit is an intimate and homogeneous mixture of metal with embedded CNTs with the desired uniform arrangement of the constituents in the structure. The deposit may accumulate, for example, in the form of a bar (so-called billet). In the following treatment steps, such as an extrusion of a bar, highly compact semi-finished products free of defects (tubes, metal sheets etc.) or moulded bodies with a lamellar structure, can be produced. The semi-finished products and moulded bodies, for example have a more or less pronounced anisotropy in the structure and mechanical and physical properties, such as electrical conductivity, heat conductivity, strength and ductility. Further applications of the duplex-aluminium materials according to the invention are in the area of neutron captors, jet moderation or the production of layers for jet protection.

The present second material component allows use as a moulded body or layer in another way, the moulded bodies being produced by thermal spray methods such as plasma spraying or cold gas spraying. In the thermal spray methods, powdery materials are injected into an energy source and only heated there, depending on the method variant, partly melted or completely melted and accelerated to high speeds (depending on the method and parameter selection, of a few m/s through to 1500 m/s) in the direction of the surface to be coated, where the impinging particles are deposited as a layer. If the ideally heated particles or the particles only partly melted on the surface impinge on the substrate with very high kinetic energy, the CNTs are preferably placed in the drop plane, i.e. transverse to the jet and impacting direction. This leads to a controlled anisotropy of the material properties such as the tensile strength.

The CNT-containing second material component can alternatively or additionally also be further processed by extrusion methods, sintering methods or pressure casting methods into moulded bodies. In pressure casting, a slow, in particular laminar, continuous mould filling is aimed for at high metal pressures. For example, composite materials can be produced by the infiltration of porous fibre or particle moulded bodies by a liquefied metal.

In pressure casting methods, the second material component made from the metal containing the CNTs is presented in a casting mould as a powdery matrix material. A metal, the melting point of which is below that of the material, for example in the case of aluminium-containing materials, a metal with a melting temperature of below 750° C., is slowly pressed into the heated casting mould. The liquid metal penetrates the powdery matrix material under the applied pressure. The casting mould can then be cooled and the moulded body can be removed from the mould. The method can also be carried out continuously. In one embodiment, the metal, for example aluminium, may be processed into pre-products exhibiting thixotropic behaviour and the CNTs incorporated. Instead of liquefied metal, a pre-heated metal in the state of thixotropic (partly liquid/partly solid) behaviour, containing the CNTs, can be pressed in the casting mould. It is also possible to fill the material in particle or granulate form, the metal being layered alternately with layers of CNTs in the individual particles, as a bulk blend into the casting mould, to heat the casting mould and to achieve complete filling of the mould without pause and bubbles in the moulded body being produced, under pressure. Finally, coarsely mixed metal powder, for example aluminium powder or aluminium having thixotropic properties, and CNTs, the CNTs in sponge form or as a cluster with a diameter of, for example up to 0.5 mm, can be coarsely mixed and pressed in the casting mould with the action of heat to melt the metal. With the pressure casting method, moulded bodies, for example rod-shaped moulded bodies, may be produced discontinuously or continuously. Aluminium with thixotropic properties can be obtained, for example, by melting aluminium or aluminium alloys and rapid cooling with constant stirring until solidification.

In a particularly preferred development, the second jet may be a jet which is identical to the first jet—in other words, the first component and the second component may, if necessary, be supplied together for example to a spray nozzle to provide a single spray jet during spray compacting. Moreover, one variant has proven above all advantageous in which a second jet formed separately from the first is used to supply the second material component to the first jet. As necessary, both or one of the jets may be formed as a spray jet. Moreover, as required, the first and the second jet may be collinear in form or, as necessary be provided at a certain angle to one another.

As already partially explained above, it has proven to be particularly advantageous for the first material component to be introduced in the molten state into the first jet. For this purpose, the first material component may be introduced, for example, by spraying through a nozzle as liquid drops into the first jet.

The second material component may be introduced in a preferred manner in the powdery state into the second jet. A particulate state of the second material component, preferably as nanoparticles, is suitable in particular for this. Such and similar particles can be shown in a particularly preferred manner according to one or more of the described milling methods. The arrangement provided according to this development of a first and a second jet separate therefrom above all ensures the introduction of the second component, without a demixing being able to take place of, for example, nanoparticles with an aluminium matrix. The sprayed-in particles are briefly melted in the hot cloud of, for example, liquid drops of the first material component, mixed homogeneously and after a comparatively short flight time, deposited together on a substrate, where the material in the form of the duplex-aluminium material immediately solidifies.

In other also suitable developments, it is moreover possible for the first material component to be introduced in the powdery state into the second jet and the second material component to be introduced in the molten state into the first jet.

In total, the aluminium-duplex materials and moulded bodies therefrom exhibit good temperature conductivity and electrical conductivity. The temperature behaviour of moulded bodies from the materials according to the invention is excellent. The thermal expansion is low. The creep elongation is improved. By adding the CNTs to the metals, such as aluminium, a substantial refinement of the grain structure to, for example, 0.6-0.7 Fm can be observed. Adding the CNTs to the metals may influence a recrystallisation of the metal or prevent it. A

spreading of a crack can be reduced or prevented by the CNTs in the metal. A material according to the invention is distinguished, in particular, by high heat-resistance.

Embodiments of the invention will now be described below with the aid of the drawings. These are not necessarily to show the embodiments to scale, rather the drawings are implemented in a schematic and/or slightly distorted form, where useful for explanation. With regard to supplements to the teachings which can be directly discerned from the drawings, reference is made to the relevant prior art. It is to be taken into account here that diverse modifications and changes relating to the form and the detail of an embodiment can be carried out without deviating from the general idea of the invention. The features disclosed in the description, in the drawings and in the claims of the invention may be important both individually and in any combination for the development of the invention. In addition all combinations of at least two of the features disclosed in the description, the drawings and/or the claims come within the scope of the invention. The general idea of the invention is not limited to the exact form or the detail of the preferred embodiment shown and described below or limited to a subject, which would be restricted in comparison to the subject claimed in the claims. With the given measurement ranges, values within the limits mentioned are also to be disclosed and usable as desired and claimable, as limit values.

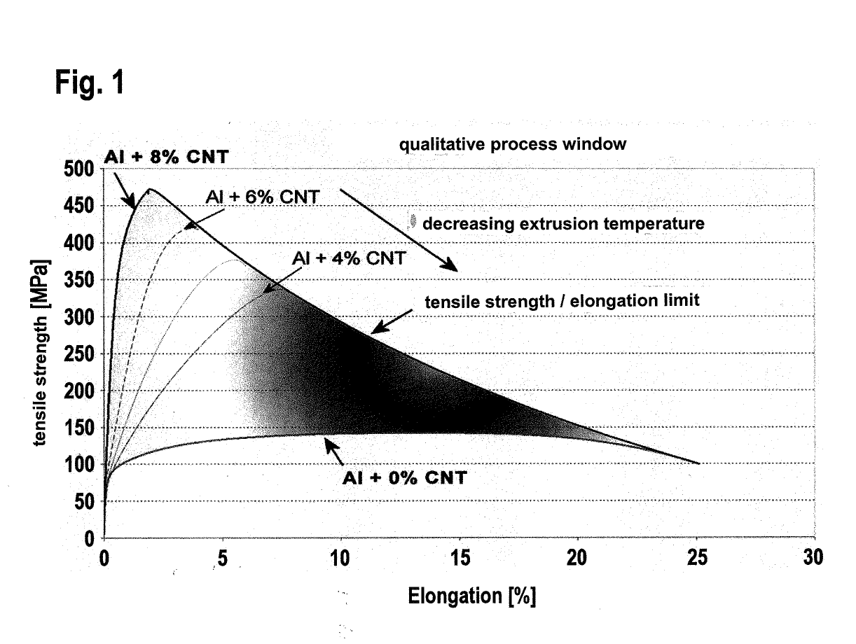

In detail, FIG. 1 to FIG. 9 of the drawing show the following:

FIG. 1: shows an illustrative plan which makes clear the possibility of a great 5 increase of the tensile strength of an aluminium-based composite with CNTs in comparison to pure aluminium;

FIG. 2: shows a schematic view of a spray compacting device for applying a duplex-aluminium material according to the concept of the invention;

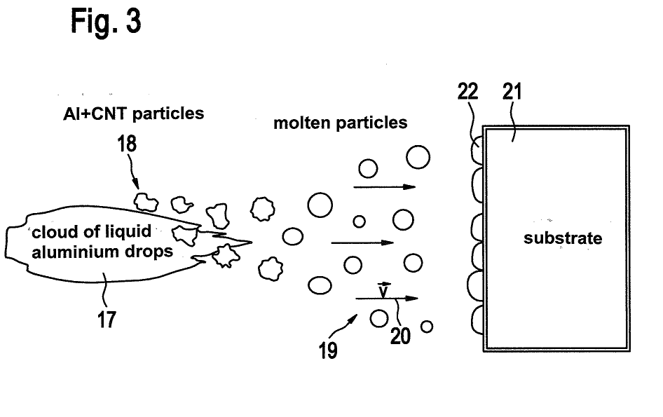

FIG. 3: shows a schematic descriptive view of the flight phase of the first material component in the form of pure aluminium and the second material component in the form of an aluminium/CNT composite;

FIG. 4: shows an exemplary micrograph of a duplex-aluminium structure in a particle of a second material component in the form of an Al/CNT composite with CNT phases to be clearly seen within the aluminium matrix;

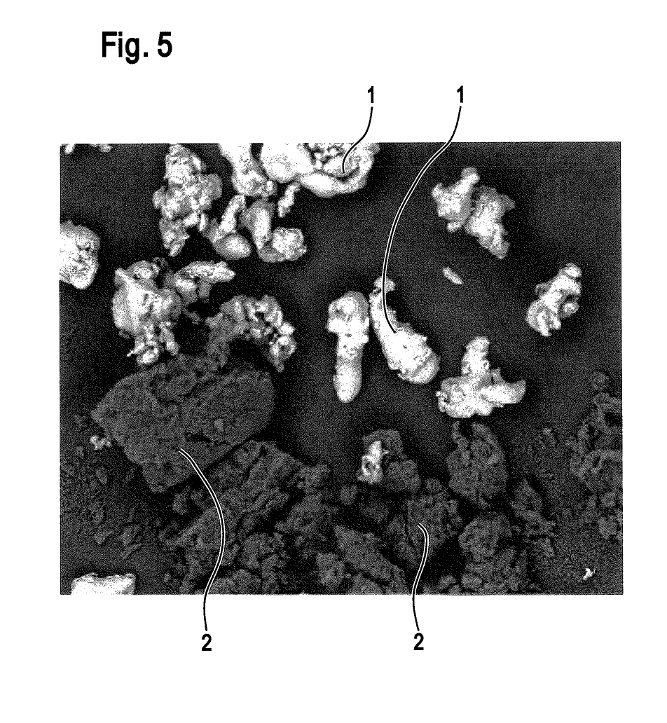

FIG. 5 to FIG. 9: show the starting products and finished material components seen through a microscope, with strong magnification in each case;

FIG. 5: shows a mixture of aluminium particles and CNT agglomerates before the mechanical alloying to form a preferred second material component, enlarged. The light aluminium particles are designated (1). The dark CNT agglomerates are designated (2);

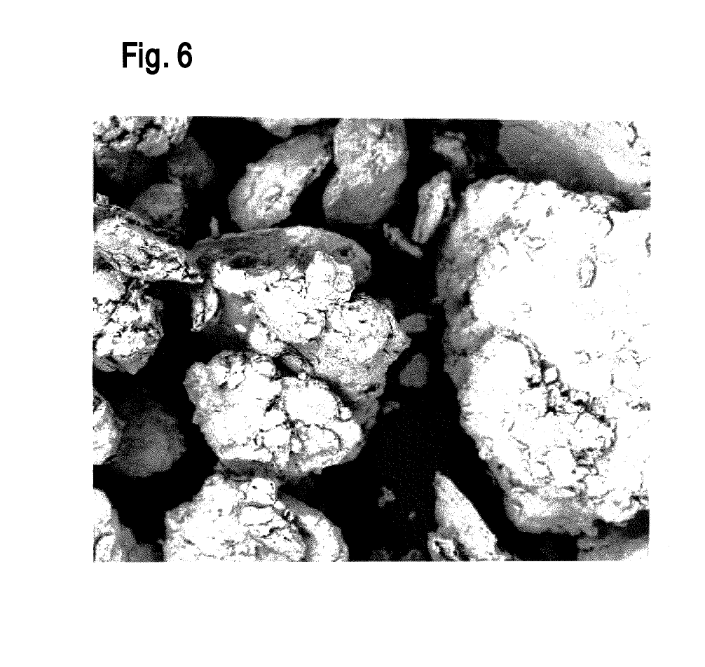

FIG. 6: shows an enlarged view of a preferred second material component in powder or particle form after mechanical alloying. No free CNTs are visible. All the CNTs are taken up into the aluminium particles, which have been frequently deformed, broken and welded;

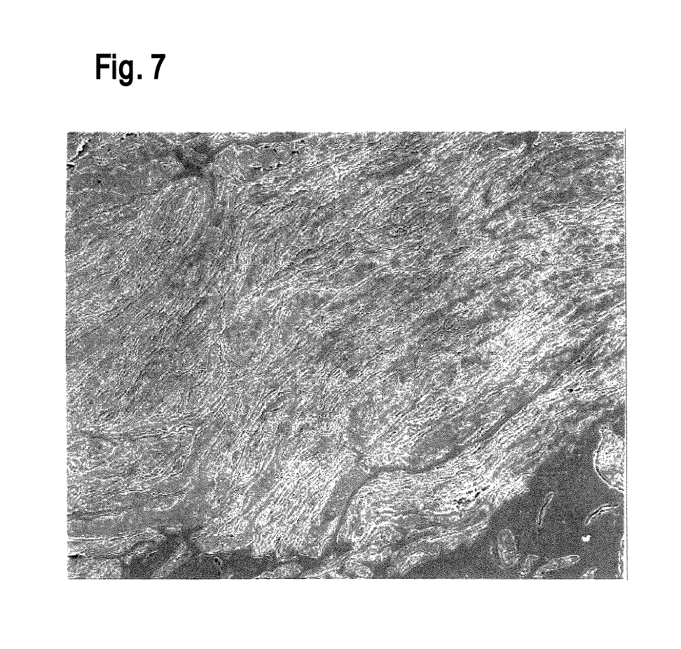

FIG. 7: shows a section through a particle of a preferred second material component in the form of an Al/CNT composite. A layer structure, or rather layers, can be seen within the particle of the material. These strata or layers of grey toned aluminium metal and light/dark linear inclusions of CNTs can be seen alternately in the picture;

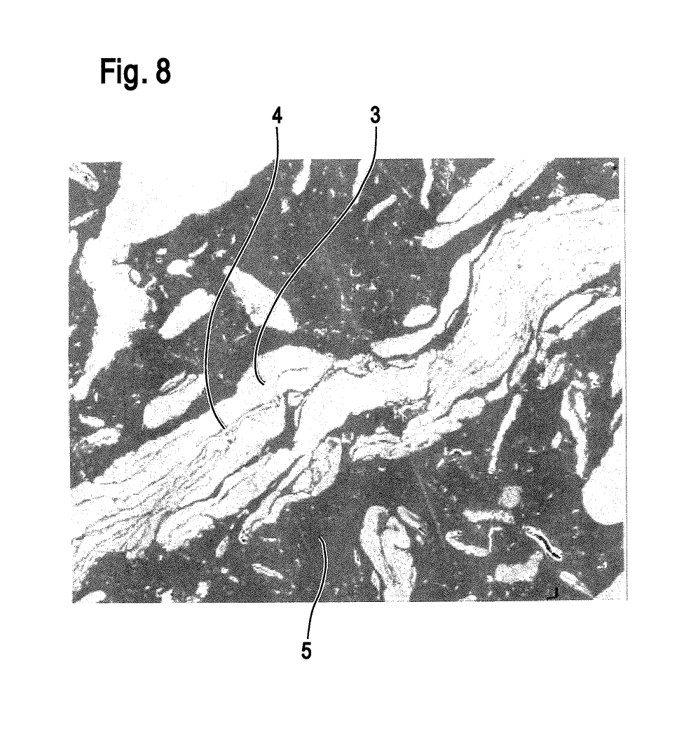

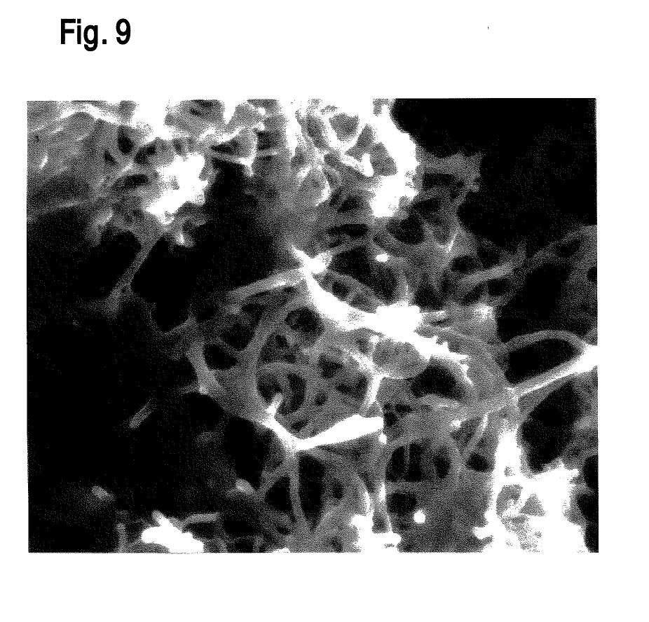

FIG. 8: shows a section through another particle of a preferred second material component in the form of an Al/CNT composite. Within a particle of the material, a layer structure, or rather layers, can be seen. These strata or layers of alternately aluminium metal (3) as a light structure and CNT (4) as dark linear inclusions are visible in the aluminium. Compared to the material of FIG. 7, the material in FIG. 9 has lower fractions of CNTs, which are separated by thicker layers of aluminium. The grey areas (5) which surround the particles, represent the resin, in which the material for the micrograph is embedded;

FIG. 9: shows a sponge structure of CNTs such as can be used, for example for producing materials according to the invention in the present case, in an electron micrograph. A sponge structure of this type can also be used, for example in the pressure casting method;

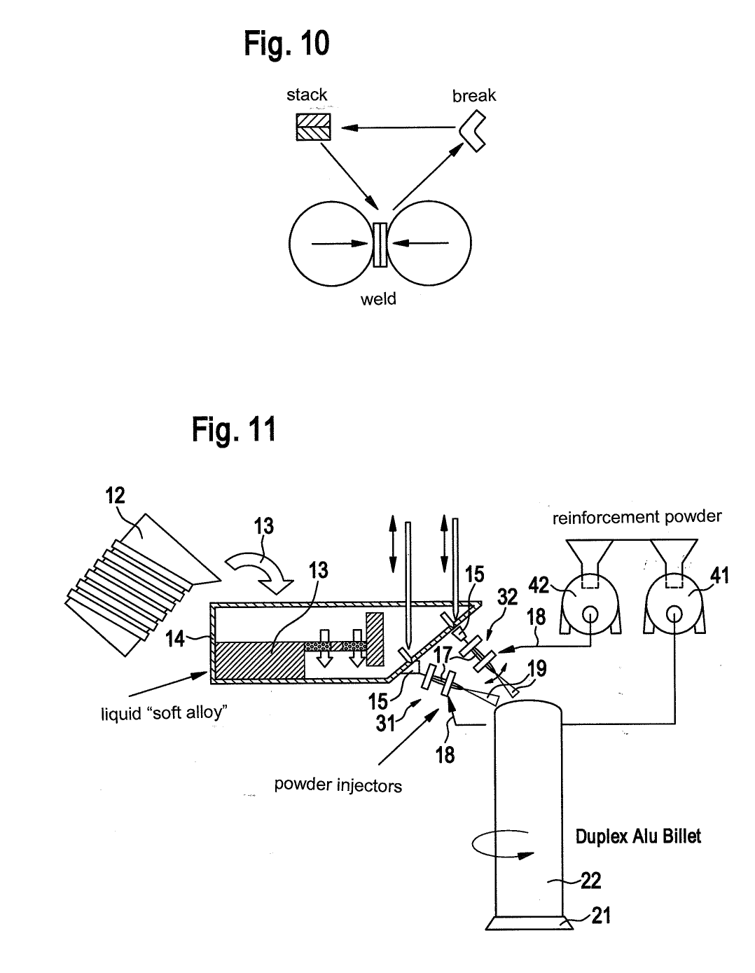

FIG. 10: schematically illustrates the processes basically occurring in mechanical alloying, of breaking, stacking and welding, which in high-frequency frequent repetition in the course of a high energy milling process leads to a so-called “severe plastic deformation” of the materials involved—consequently to materials of the second material component as shown by way of example in FIG. 6 to FIG. 8;

FIG. 11: shows a schematic view of a further embodiment of a spray compacting device for applying a duplex-aluminium material according to the concept of the invention;

FIG. 12: shows a volume fraction effect of a hard and soft component with respect to the tensile strength and elongation as a function of the volume fraction of the hard material as a percentage of the finished duplex-aluminium material;

FIG. 13: shows the CNT content dependency of the tensile strength and elongation as a function of the CNT content in % by weight of an aluminium material such as can be used in particular for a harder second material component according to the concept of the invention;

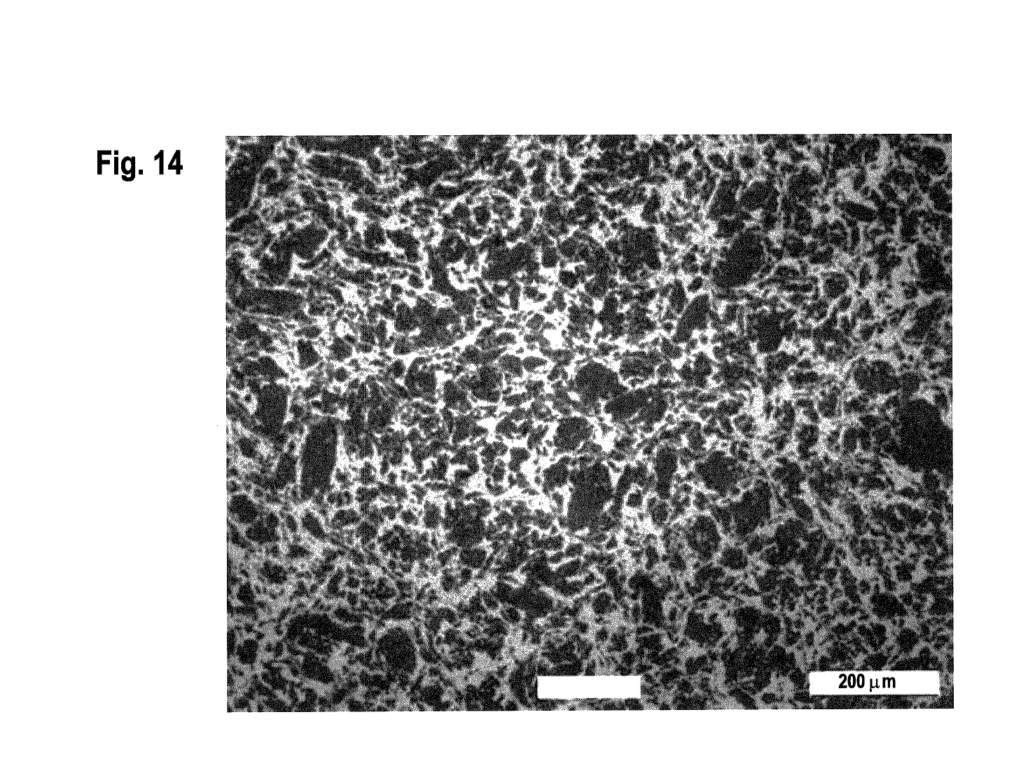

FIG. 14: shows the electron micrograph of a preferred duplex-aluminium material such as was obtained using an advantageous spray compacting method according to the concept of the invention.

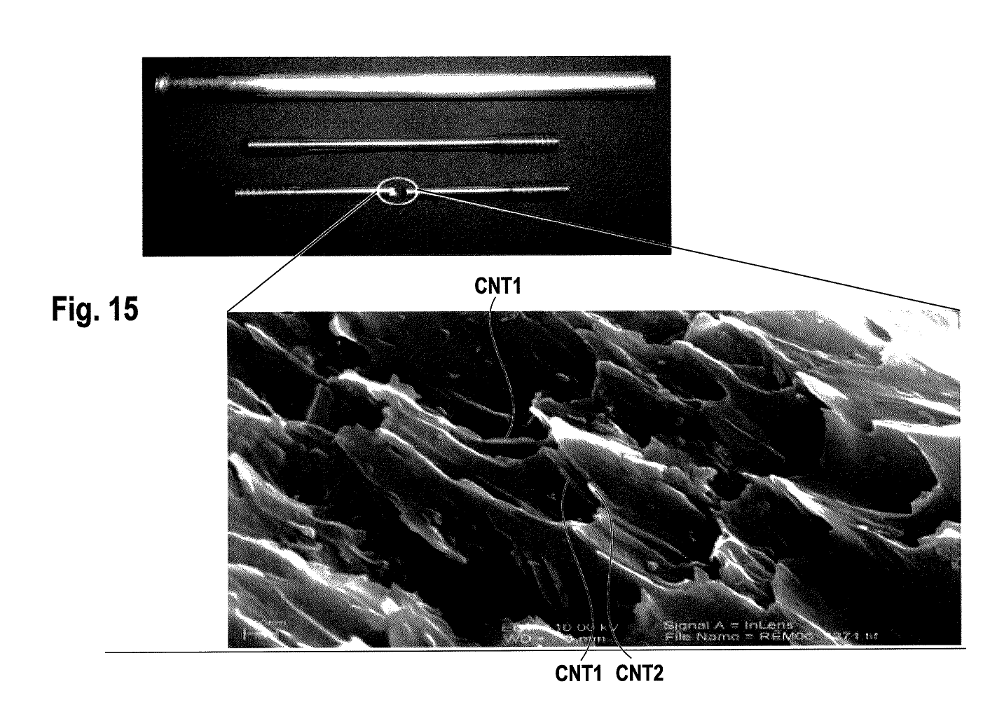

FIG. 15: shows a typical crack image from an electron micrograph in a tension specimen of a tension rod produced from the duplex-aluminium material according to the invention.

### EXAMPLES

By mechanical alloying of a powder of pure aluminium and CNTs by highly energetic milling in a pebble mill, in which a pebble speed of over 11 m/s is achieved, various materials are produced by various milling periods. The materials are further processed by a powder extrusion method and a series of rod-shaped test specimens is produced. The test specimens are subjected to the tests listed in the table. The temperature information in the table signifies the processing temperature during the extrusion method. The test specimens contain 6% by weight of CNTs. The time information 30, 60 and 120 min give the milling period during mechanical alloying to produce the materials. Example 1 is a comparative test with pure aluminium, without CNTs.

| | | Tensile | | Modulus of |
|---|---|---|---|---|
| | Material/Milling | strength | Brinell | elasticity |
| Example No. | period | N/mm² | hardness | KN/mm² |
| Literature | Pure Al | 70-100 | 35.9 | 70 |
| (bulk) | | | | |
| Example 1, | Pure Al, | 138-142 | 40.1 | 71-81 |
| Example 2, | 30 min, | 222-231 | 66.4 | 98-101 |
| Example 3, | 60 min, | 236-241 | 71.1 | 71-78 |
| Example 4, | 120 min, | 427-471 | 160.2 | 114-125 |

It can be seen from the table that the tensile strength and hardness are increased by about 400% in each case. The values can be controlled by the content of CNTs in the material and the milling process, such as the milling period, for producing the material. The modulus of elasticity may be increased by 80%. The modulus of elasticity may have an influence through the milling period during the mechanical alloying in the production of the material and through the processing temperature in the extrusion method.

FIG. 1 shows a series of tensile strength/ductility curves relating to a second material component in the form of an intimate mixture of an Al/CNT composite in comparison to pure aluminium (Al+0% CNTs). The highest points showing the tensile strength of such curves are in the present case called the “stress/strain limit” and show that—for example in the case of an aluminium-based composite with 8% CNTs (Al+8% CNTs)—the tensile strength of a composite of this type is above the tensile strength of pure aluminium by virtually a factor of 5. Below this, tensile strength values can be achieved with smaller CNT fractions (e.g. Al+6% CNTs or Al+4% CNTs) in which composites it is also ensured that the ductility is nevertheless comparatively high. Aluminium-based composites with a smaller CNT fraction also have the advantage that an extrusion temperature is comparatively low.

FIG. 2 shows the diagram of a spray compacting device 11, in which for example, pure aluminium present in a crucible 12 as a melt 13 can be supplied to a tundish 14, to then be supplied in a spray nozzle 15 atomising the liquid into finely distributed drops to a first jet 16 with an expediently selected spray cone. A separate jet not shown in the present case and generally slightly deviating collinearly or at an angle, sprays powder particles of the second material component, presently in the form of a pure aluminium/CNT composite, into the spray cone of the first spray jet 16. The cloud schematically shown in FIG. 3 of liquid pure aluminium drops 17 and the composite of Al/CNT particles 18 in a partly molten state 19 reach, at a suitable impact speed 20, the substrate 21 and solidify immediately there to form a test specimen 22.

A micrograph of a particle of a second material component in the form of an Al/CNT composite for producing a test specimen of this type is shown in FIG. 4. The structural forms obtained of the CNT parts inside the aluminium platelets can clearly be seen therein at the light points. Such high-strength structural constituents with integrated CNTs are surrounded by parts, which are shown dark, of a soft structural form of pure aluminium. In total, an aluminium-duplex material is thereby provided, which combines a first material component with comparatively high ductility and low tensile strength with a second material component with comparatively low ductility and high tensile strength as a phase mixture.

FIG. 10 illustrates the important processes occurring in a high-energy milling method for mechanical alloying—namely welding, breaking and stacking—which ultimately lead to a strong plastic deformation of the materials involved (severe plastic deformation). When using the high-energy milling method on a mixture of preferred harder aluminium alloy with CNT material, this consequently leads to a very strong solidification of the materials involved by milling and consequently to a particularly preferred second (harder) material component according to the concept of the invention. The solidification takes place here substantially according to the known HALL-PETCH relationship. This states that the smaller the diameter of the particles involved, the greater is also the maximum achievable tensile strength. Specifically, according to the HALL-PETCH relationship, the maximum achievable tensile strength P should be inversely proportional to the root of the particle diameters involved, the validity of the relationship in any case beginning below 1 μm for particle diameters. The high-energy milling of aluminium materials, such as, for example, pure aluminium or an aluminium alloy of comparatively high hardness with CNTs not only has the advantage made clear in FIG. 10 that the CNT fraction is intimately incorporated into the aluminium material, but additionally the advantage occurs that CNT is used as an auxiliary milling agent. According to a particularly preferred embodiment, the fraction of previously conventional auxiliary milling agents such as stearic acid or the like can thereby be reduced or be dispensed with completely.

FIG. 11 shows schematically—in a modification of a method shown schematically in FIG. 2 for producing a duplex-aluminium material—a production method, in which two non-collinear spray jets 31,32 are used to apply the first and second material component. Other identical parts or parts with the identical function of FIG. 11 and FIG. 2 and FIG. 3 are provided with the same reference numerals. In the present case, two powder injectors 41, 42, for the powdery introduction of the second component into a carrier jet 31,32 of liquid aluminium drops 17 are used. In this case, the angle between the first spray jet 31 and 32 may be changed—in the present case by adjusting the second spray jet 32. Likewise, in the present case, the powder quantity can be adjusted as necessary for introduction into the first and second spray jet 31, 32. Optionally, in a modification, the first spray jet 31 may be free of a powder introduction, i.e. be fed merely from aluminium material, such as, for example pure aluminium or alloyed aluminium.

An advantageous billet of an aluminium-duplex material can be produced by arrangements of this type and others. On the one hand, it is namely recognized that using purely powdery CNTs, no billet would be produced. On the other hand, it was recognised that with strong heating of CNTs, in particular above 600° C., aluminium carbide would be produced. The latter would lead to a material produced being very prone to a splitting process. By introducing this powdery CNT-containing second material component into a liquid phase of a spray jet with liquid aluminium drops 17, preferably of pure aluminium or a harder aluminium alloy, this is prevented. The short flight time also prevents opposing chemical reactions. It has proven advantageous, in particular, for two spray nozzles or two spray jets to be used to form the duplex-aluminium body.

In an advantageous subsequent production step, a further compaction can take place by an extrusion process or the like, for example, on the billet.

FIG. 13 shows, by way of example, the tensile strength and elongation behaviour of an aluminium material component to be preferred as a function of the CNT content to form the (harder) second material component according to the concept of the invention. An aluminium alloy of the 7000 series may be used, for example, as a starting alloy, the elongation of which is maximal with a low CNT content. A CNT content in the second material component has proven to be particularly advantageous such that a decrease in the elongation in the range between 10% and 30% is present. The tensile strength in this case is advantageously also in the upper tensile strength range, in particular between the maximum tensile strength value and the intersection point with the elongation curve. It has been found that a CNT content in the region of the intersection region between the tensile strength curve and elongation curve is advantageous.

FIG. 12 shows, by way of example, the development of the tensile strength and elongation in a finished duplex-aluminium material with an increasing fraction of the (harder) second material component as a percentage of the finished duplex-aluminium material. It is made clear by this that practically any desired advantageous high value of a tensile strength with nevertheless high maximum elongation can be adjusted by varying the volume fraction of the hard material in the form of the second harder material component.

FIG. 14 shows the fine, non-homogenous, but uniform distribution of the harder second material component and softer first material component in a finished duplex-aluminium material. The hard phase of the duplex-aluminium material can be seen in the light regions. The soft phase of the duplex-aluminium material can be seen in the dark regions.

FIG. 15, in the lower enlarged region, shows a typical crack image of a tension rod shown in the upper part of FIG. 15. With reference to the marking CNT-1 and CNT-2, CNTs of different lengths embedded in the aluminium material can clearly be seen.

To summarise, the invention provides the processing of a composite material in particle or powder form, containing carbon nanotubes (CNTs), in which, in the material, for example, a metal is layered in layers in a thickness of 10 nm to 500,000 nm alternately with layers of CNT in a thickness of 10 nm to 100,000 nm. The material is produced by mechanical alloying i.e. by repeated deformation, breaking and welding of metal particles and CNT particles, preferably by milling in a pebble mill, containing a milling chamber and milling pebbles as the milling bodies and a rotating body to produce highly energetic pebble collisions. To produce duplex-aluminium, a method is described, in which a material of the composite material and an aluminium alloy with different properties are alloyed in an Ospray process.

1. Duplex-aluminium material based on aluminium comprising a first phase and a second phase, which is produced in a spray compacting method, with at least a first material component introduced by means of a first jet in the form of an aluminium-based alloy to form the first phase and at least a second material component introduced by means of a second jet to form the second phase, wherein the second material component is in the form of an aluminium-based composite material, the composite material having aluminium and/or an aluminium-based alloy, in combination with a material containing a non-metal, the first material component, in comparison to the second material component, in each case as a separate material, having a higher elongation an/or a lower tensile strength.

2. Duplex-aluminium material according to claim 1, wherein the second material component in comparison to the first material component, in each case as a separate material, has a lower elongation and/or a higher tensile strength.

3. Duplex-aluminium material according to claim 1, wherein the first material component, as a separate material, has a tensile strength of less than 100 MPa and/or a maximum elongation of more than 15%.

4. Duplex-aluminium material according to claim 1, wherein the second material component, as a separate material, has a tensile strength of more than 500 MPa and/or a maximum elongation of less than 3%.

5. Duplex-aluminium material according to claim 1, wherein the first material component is in the form of pure aluminium with inevitable impurities and/or additions.

6. Duplex-aluminium material according to claim 1, wherein the first material component is in the form of an aluminium alloy with inevitable impurities and/or additions.

7. Duplex-aluminium material according to claim 1, wherein the second material component is in the form of an intimate mixture formed by mechanical alloying of pure aluminium and/or an aluminium-based alloy in combination with CNTs.

8. Duplex-aluminium material according to claim 1, wherein the first and/or the second material component also includes at least one of a plastics material, a polymer, and a graphite and/or silicon constituent or other highly heat resistant constituent.

9. Duplex-aluminium material according to claim 1, wherein the second jet is a collinear jet which is identical to the first jet.

10. Duplex-aluminium material according to claim 1, wherein the first material component is introduced in the molten state into the first jet.

11. Duplex-aluminium material according to claim 1, wherein the second material component is introduced in a powdery state into the second jet.

12. Duplex-aluminium material according to claim 1, wherein the first material component is introduced in a powdery state into the second jet and the second material component is introduced in a molten state into the first jet.

13. Duplex-aluminium material according to claim 1, wherein, in the material, at least one metal and/or at least one plastics material is layered alternately with layers of CNTs.

14. Duplex-aluminium material according to claim 1, wherein a particle size of the second material component is from 0.5 μm to 2000 μm.

15. Duplex-aluminium material according to claim 1, wherein individual layers of a metal or plastics material have a thickness of 10 nm to 500,000 nm.

16. Duplex-aluminium material according to claim 1, wherein thicknesses of layers containing CNTs are from 10 nm to 100,000 nm.

17. Duplex-aluminium material according to claim 1, wherein within the particles of the material, at least one metal or plastics material is layered alternately with layers of CNTs in a uniformly arranged layer thickness.

18. Duplex-aluminium material according to claim 1, wherein within the particles of the material, at least one metal or plastics material is layered alternately with layers of CNTs, regions with a high concentration of CNT layers and a low concentration of metal or plastics material layers being present within the particle.

19. Duplex-aluminium material according to claim 1, wherein through the particles of the material, a plurality of CNT layers contact one another in part regions and through the particles form uninterrupted CNT penetrations.

20. Duplex-aluminium material according to claim 1, further comprising a least one metal, in addition to aluminium or the alloys thereof, selected from a group consisting of ferrous metals from the series of iron, cobalt and nickel, the alloys thereof and steels, other ferrous metals, aluminium, magnesium and titanium and alloys thereof, metals from the series of vanadium, chromium, manganese, copper, zinc, tin, tantalum or tungsten and alloys thereof or the alloys from the series of brass and bronze or metals from the series of rhodium, palladium, platinum, gold and silver, other non-ferrous metals, as one type alone or in mixtures with one another.

21. Duplex-aluminium material according to claim 1, further comprising at least one polymer selected from a group consisting of: thermoplastic, elastic or thermosetting polymers, including at least one of polyolefins, cycloolefin copolymers, polyamides, polyesters, polyacrylonitrile, polystyrenes, polycarbonates, polyvinyl chloride, polyvinyl acetate, styrene-butadiene copolymers, acrylonitrile-butadiene copolymers, polyurethanes, polyacrylates and copolymers, alkyd resins, epoxides, phenol-formaldehyde resins, and urea formaldehyde resins, as one type alone or in a mixture with one another.

22. Duplex-aluminium material according to claim 1, wherein the CNTs have a diameter of 0.4 nm to 50 nm and a length of 5 nm to 50,000 nm.

23. Duplex-aluminium material according to claim 1, wherein the CNTs are 2- or 3-dimensional structural bodies, made of carbon nanotubes, preferably structural bodies with side lengths of 10 nm to 50,000 nm.

24. Duplex-aluminium material according to claim 1, wherein the material contains quantities of CNTs of 0.1 to 50% by weight, based on the material.

25. Duplex-aluminium material according to claim 1, wherein aluminium or an aluminium alloy is the metal of the material and the material contains 0.5 to 10% by weight CNTs.

26. Method for producing a duplex-aluminium material according to claim 1, comprising:
processing fractions of aluminium and/or an aluminium-based alloy and a nonmetal, in each case in the form of granulates, particles, fibres and/or powders by mechanical alloying, in order to provide the second material component in the form of an aluminium-based composite material, having aluminium and/or an aluminium-based alloy in combination with the material containing the non-metal.
spray compacting the duplex-aluminium material based on aluminium with a first phase and a second phase, by
introducing a first material component in the form of an aluminium-based alloy to form the first phase in at least a first jet
introducing the second material component to form the second phase in at least a second jet, wherein
the first material component, in comparison to the second material component, in each case as a separate component, has a higher ductility and/or lower tensile strength.

27. Method for producing a duplex-aluminium material according to claim 26, wherein a mechanical alloying is carried out by repeated deformation, breaking and welding of particles of metal or plastics material and particles of CNTs, by mechanical alloying in a pebble mill containing a milling chamber and milling pebbles as milling bodies by highly energetic pebble collisions.

28. Method for producing a duplex-aluminium material according to claim 27, wherein the pebble mill has the milling chamber with a cylindrical, cross section and the milling pebbles are moved by the milling chamber rotating about a cylinder axis and accelerated by a driven rotating body extending in the direction of the cylinder axis into the milling chamber and equipped with a plurality of cams.

29. Method for producing a duplex-aluminium material according to claim 27, wherein the speed of the milling pebbles is at least 6 m/s.

30. Method for producing a duplex-aluminium material according to claim 27, wherein a milling period is between 5 minutes and 10 hours.

31. Method for producing a duplex-aluminium material according to claim 28, wherein the rotating body has a plurality of cams distributed over the entire length and extends over the entire extent of the milling chamber in the cylinder axis.

32. Method for producing a duplex-aluminium material according to claim 26, wherein two or more different materials of the same or different starting material and/or energy input are mixed or subjected to at least a second milling.

33. Method for producing a duplex-aluminium material according to claim 26, wherein a CNT-free metal or plastics material and at least one material of the same or different starting material and/or energy input are mixed or subjected to at least a second milling.

34. Use of the duplex-aluminium material according to claim 1 for moulded bodies produced by a technique selected from a group consisting of: a spray compacting, thermal spray methods, plasma spraying, extrusion methods, sintering methods, pressure-controlled infiltration methods or pressure casting.

35. Duplex-aluminium material according to claim 3, wherein the first material component, as a separate material, has a tensile strength of less than 70 MPa, and/or a maximum elongation of more than 20%.

36. Duplex-aluminium material according to claim 4, wherein the second material component, as a separate material, has a tensile strength of more than 1000 MPa, and/or a maximum elongation of less than 1%.

37. Duplex-aluminium material according to claim 9, wherein the second jet is a spray jet.

38. Duplex-aluminium material according to claim 10, wherein the first material component is introduced into the first jet as liquid drops sprayed through a nozzle into the first jet.

39. Duplex-aluminium material according to claim 11, wherein the second material component is introduced as nanoparticles into the second jet, without demixing of the aluminium and/or the aluminium-based alloy and the material containing the non-metal.

40. Duplex-aluminium material according to claim 14, wherein the particle size of the second material component is from 1 μm to 1000 μm.

41. Duplex-aluminium material according to claim 15, wherein individual layers of a metal or plastics material have a thickness of 20 nm to 200,000 nm.

42. Duplex-aluminium material according to claim 16, wherein thicknesses of layers containing CNTs are from 20 nm to 50,000 nm.
